(19) United States
(12) Patent Application Publication
(10) Pub. No.: US 2002/0159048 A1
(43) Pub. Date: Oct. 31, 2002

(54) Wavefront aberration measuring method and unit, exposure apparatus, device manufacturing method, and device

(75) Inventors: Fuyuhiko Inoue, Tokyo (JP); Toru Fujii, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Nikon Corporation, Tokyo (JP)

(21) Appl. No.: 10/080,537

(22) Filed: Feb. 25, 2002

(30) Foreign Application Priority Data
Feb. 23, 2001 (JP) 2001-047,693

(51) Int. Cl. G01J 1/00

(52) U.S. Cl. 356/121

(57) ABSTRACT

First, the wave-front aberration in an optical system PL subject to measurement is measured using a measuring system 70 according to a usual method. After that, by using calculated correction information for aberration components of a second set of order terms based on a model for the measuring system 70 and aberration components of a first set of order terms measured before, the result of measuring aberration components of the second set of order terms is corrected. As a result, aberration components of the second set of order terms can be accurately obtained, so that the wave-front aberration in the optical system subject to measurement is accurately obtained.

### BACKGROUND OF THE INVENTION

1. Field of The Invention

The present invention relates to a wave-front aberration measuring method and unit, an exposure apparatus, a device manufacturing method, and device, and more specifically to a wave-front aberration measuring method and unit for measuring a wave-front aberration characteristic of an optical system to be examined, an exposure apparatus comprising the wave-front aberration measuring unit, a device manufacturing method using the exposure apparatus and a device manufactured by the device manufacturing method.

2. Description of The Related Art

In a lithography process for manufacturing semiconductor devices, liquid crystal display devices, or the like, exposure apparatuses have been used which transfer a pattern (also referred to as a “reticle pattern” hereinafter) formed on a mask or reticle (generically referred to as a “reticle” hereinafter) onto a substrate, such as a wafer or glass plate (hereinafter, generically referred to as a “substrate” as needed), coated with a resist through a projection optical system. As such an exposure apparatus, a stationary-exposure-type projection exposure apparatus such as the so-called stepper, or a scanning-exposure-type projection exposure apparatus such as the so-called scanning stepper is mainly used.

Such an exposure apparatus needs to accurately project the pattern on a reticle onto a substrate with high resolving power. Therefore, the projection optical system is designed to have a wave-front aberration greatly reduced.

However, even if, in the making of a projection optical system separately, the wave-front aberration is greatly reduced as is planned in design, the wave-front aberration often increases due to various factors after installing the projection optical system in an exposure apparatus. The amount of the wave-front aberration may vary with time.

Various techniques have been suggested for measuring the wave-front aberration in an optical system subject to measurement such as a projection optical system installed in an exposure apparatus in the state where the optical system is actually installed in the apparatus. Among the various techniques, the Shack-Hartmann technique is attracting attention which divides the wave-front on the pupil plane of the projection optical system into a plurality of square areas (may actually divide; hereinafter, called “divided wave-front portions”) and measures the gradient of each divided wave-front portion to obtain aberration of the portion and thus aberration of the whole wave-front.

A wave-front aberration measuring method following the Shack-Hartmann technique is known where a micro-lens array in which a plurality of micro lenses are arranged along a two-dimensional plane parallel to the ideal wave front of the parallel rays of light divides the wave-front of incident light through the optical system, and which detects the positions of a lot of spot images which are formed by the respective divided wave-front portions. This method obtains the tilt of the wave-front of an incident light beam on each micro-lens relative to the ideal wave-front (flat plane) from the positions of the spot images detected and, based on the tilts (gradients), obtains the whole wave-front of the incident light on the micro-lens array to obtain the wave-front aberration characteristic of the optical system.

Another wave-front aberration measuring method following the Shack-Hartmann technique is known where the wave-fronts of light beams through a plurality of pattern sub-areas on a mask pass through corresponding sub-areas on the pupil plane of the optical system (the whole wave-front being actually divided), and which detects the positions at which the plurality of pattern sub-areas are imaged through the optical system. This method obtains the gradients of the wave-fronts of light beams having passed through the plurality of pattern sub-areas and then the optical system from the imaging positions detected and, based on the gradients, obtains the whole wave-front of the incident light on the pattern area to obtain the wave-front aberration characteristic of the optical system.

The above wave-front aberration measuring methods following the Shack-Hartmann technique are excellent in terms of quickly measuring the wave-front aberration characteristic of an optical system because they can observe pattern images corresponding to the respective divided wave-front portions at one time.

It is remarked that in measuring the wave-front aberration according to the Shack-Hartmann technique, when the micro-lens array divides the wave-front of light having passed through the optical system, the dimension of divided wave-front portions is determined by the dimension of micro-lenses of the micro-lens array, and that when the pattern sub-areas of the mask divide the wave-front of light incident on the optical system, the dimension of divided wave-front portions is determined by the dimension of the pattern sub-areas.

The dimension of divided wave-front portions determines a limit at or below which space frequencies can be dealt with in measuring the wave-front aberration, and according to the Shannon's sampling theory a shape whose space-frequency component has a period of not larger than double the dimension of divided wave-front portions cannot be measured. Such higher frequency components introduce error into the amplitudes of lower frequency components measured, which phenomenon is called aliasing. While in order to reduce the aliasing, the dimension of sampled wave-front portions, i.e., divided wave-front portions needs to be small, there is a limit to making the dimension of the micro lens or pattern sub-area small.

Therefore, when the wave-front aberration measured according to the Shack-Hartmann technique is expanded in terms of, e.g., fringe Zernike polynomials, the amount of aberration components which are coefficients of lower-order terms corresponding to lower space-frequencies may be affected by higher-order terms corresponding to higher space-frequencies.

Moreover, because optical elements such as lenses forming part of the optical system such as a projection optical system have a cylinder-symmetrical shape, the wave-front aberration in the optical system is suitably expressed in polar coordinates. Meanwhile, in measuring the wave-front aberration according to the Shack-Hartmann technique the wave-front is divided by a two-dimensional orthogonal grid. Because, as described above, the coordinate system suitable to express the wave-front aberration and the coordinate system for detecting imaging positions of the pattern are different in form, the aliasing may cause the component of an order term to blend into the component of another order term in the measuring result.

Therefore, measuring the wave-front aberration according to the prior art Shack-Hartmann technique has a limit to improving the accuracy in measuring the wave-front aberration because of the possibility of cross talk between order terms where, when the wave-front aberration is expanded in a basis (or series), the aberration component of an order term blends into the aberration component of another order term in the measuring result.

### DISCLOSURE OF INVENTION

This invention was made under such circumstances, and a first purpose of the present invention is to provide a wave-front aberration measuring method and unit that can improve accuracy in measuring the wave-front aberration in an optical system subject to measurement.

Furthermore, a second purpose of the present invention is to provide an exposure apparatus that can accurately transfer a given pattern onto a substrate.

Moreover, a third purpose of the present invention is to provide a highly integrated device having a fine pattern thereon and a device manufacturing method which can manufacture such devices.

According to a first aspect of the present invention, there is provided a wave-front aberration measuring method with which to measure a wave-front aberration in an optical system subject to measurement, said measuring method comprising measuring, first, aberration components of a first set of order terms out of aberration components of order terms of a predetermined basis in which the wave-front aberration in said optical system is expanded; calculating correction information for aberration components of a second set of order terms based on a predetermined order term's aberration component out of the aberration components of said first set of order terms; measuring aberration components of said second set of order terms in said optical system; and correcting the result of said measuring of aberration components of said second set of order terms based on said correction information. Here, the number of order terms composing the set may be one, not being limited to more than one. That is, for example, the first set of order terms may consist of one order term or a plurality of order terms. Herein, the word “set” has such meaning.

According to this, first, aberration components of a first set of order terms are measured, for example, upon making the optical system, when it is possible to very accurately measure higher-order, as well as lower-order, terms of a predetermined basis (series) in which the wave-front aberration is expanded, because enough time can be spent on measurement and restriction on measurement resources provided is little. Correction information for aberration components of a second set of order terms to be measured later is calculated based on a predetermined order term's aberration component out of the aberration components of the first set of order terms measured.

Then, aberration components of the second set of order terms in the optical system are measured, for example, after installing the optical system in the apparatus. Upon the measurement, order term' aberration components that are expected to vary since the making thereof are measured. And the result of measuring aberration components of the second set of order terms is corrected based on the correction information. As a result, aberration components of the second set of order terms can be accurately obtained.

In the wave-front aberration measuring method according to this invention, the expansion in said predetermined basis may be an expansion in a set of fringe Zernike polynomials. Here, the “expansion in a set of fringe Zernike polynomials” means an expansion given by the expression (1),

$$W ( ρ , θ ) = {\sum }_{i} \{ {Z}_{i} \cdot {f}_{i} ( ρ , θ ) \} \qquad ( 1 )$$

where W(ρ, θ) represents the wave-front (aberration) expressed in polar coordinates (ρ, θ).

Table 1 shows functions fᵢ(ρ, θ) (i=1 through 36) in the expression (1). The wave-front (aberration) is expanded in Zernike polynomials, each of which expresses an n'th order mθ term that is a product of an n'th order polynomial including radial distance ρ to the n'th power and a trigonometric function of angular coordinate θ multiplied by m, and in the expansion in fringe Zernike polynomials, terms are arranged in ascending order of the sum (n+m) and, when values of the sum are the same, in ascending order of n. The value of i in the expression (1) denotes an order in the expansion in fringe Zernike polynomials. Incidentally, coefficients of higher than first order terms and not coefficient Z₁, of the first order term are measured in the measurement of wave-front aberration according to the Shack-Hartmann technique.

TABLE 1

| Zi | fi | Zi | fi |
|---|---|---|---|
| Z1 | 1 | Z19 | (5ρ⁵ − 4ρ³) cos 3θ |
| Z2 | ρ cos θ | Z20 | (5ρ⁵ − 4ρ³) sin 3θ |
| Z3 | ρ sin θ | Z21 | (15ρ⁶ − 20ρ⁴ + 6ρ²) cos 2θ |
| Z4 | 2ρ² − 1 | Z22 | (15ρ⁶ − 20ρ⁴ + 6ρ²) sin 2θ |
| Z5 | ρ² cos 2θ | Z23 | (35ρ⁷ − 60ρ⁵ + 30ρ³ − 4ρ) cos θ |
| Z6 | ρ² sin 2θ | Z24 | (35ρ⁷ − 60ρ⁵ + 30ρ³ − 4ρ) sin θ |
| Z7 | (3ρ³ − 2ρ) cos θ | Z25 | 70ρ⁸ − 140ρ⁶ + 90ρ⁴ − 20ρ² + 1 |
| Z8 | (3ρ³ − 2ρ) sin θ | Z26 | ρ⁵ cos 5θ |
| Z9 | 6ρ⁴ − 6ρ² + 1 | Z27 | ρ⁵ sin 5θ |
| Z10 | ρ³ cos 3θ | Z28 | (6ρ⁶ − 5ρ⁴) cos 4θ |
| Z11 | ρ³ sin 3θ | Z29 | (6ρ⁶ − 5ρ⁴) sin 4θ |
| Z12 | (4ρ⁴ − 3ρ²) cos 2θ | Z30 | (21ρ⁷ − 30ρ⁵ + 10ρ³) cos 3θ |
| Z13 | (4ρ⁴ − 3ρ²) sin 2θ | Z31 | (21ρ⁷ − 30ρ⁵ + 10ρ³) sin 3θ |
| Z14 | (10ρ⁵ − 12ρ³ + 3ρ) cos θ | Z32 | (56ρ⁸ − 105ρ⁶ + 60ρ⁴ − |
| | | | 10ρ²) cos 2θ |
| Z15 | (10ρ⁵ − 12ρ³ + 3ρ) sin θ | Z33 | (56ρ⁸ − 105ρ⁶ + |
| | | | 60ρ⁴ − 10ρ²) sin 2θ |
| Z16 | 20ρ⁶ − 30ρ⁴ + 12ρ² − 1 | Z34 | (126ρ⁹ − 280ρ⁷ + 210ρ⁵ − |
| | | | 60ρ³ + 5ρ) cos θ |
| Z17 | ρ4 cos 4θ | Z35 | (126ρ⁹ − 280ρ⁷ + 210ρ⁵ − |
| | | | 60ρ³ + 5ρ) sin θ |
| Z18 | ρ4 sin 4θ | Z36 | 252ρ¹⁰ − 630ρ⁸ + 560ρ⁶ − |
| | | | 210ρ⁴ + 30ρ² − 1 |

In the wave-front aberration measuring method according to this invention, said first set of order terms may include all of a lowest order term through a first ordinal order term in said expansion, and wherein said second set of order terms may include all of said lowest order term through a second ordinal order term in said expansion, said second ordinal being lower than said first ordinal. Because, as described above, coefficient Z₁, of the first order term is not measured in the measurement of wave-front aberration according to the Shack-Hartmann technique, the lowest order is the second order.

In the wave-front aberration measuring method according to this invention, said predetermined order term may be included in said first set of order terms and not in said second set of order terms; calculating said correction information may comprise calculating a first wave-front with letting aberration components of other order terms of said first set of order terms measured than said predetermined order term be zero and calculating as said correction information respective correction amounts for aberration components of said second set of order terms based on a model for a measuring system that measures aberration components of said second set of order terms and said first wave-front, and the aberration components of said second set of order terms measured may be individually corrected based on said correction information.

In the wave-front aberration measuring method according to this invention, said predetermined order term may be included in said first set of order terms and not in said second set of order terms; calculating said correction information may comprise calculating as said correction information a first wave-front with letting aberration components of other order terms of said first set of order terms measured than said predetermined order term be zero, and correcting based on said correction information may comprise calculating a second wave-front that has aberration components of said second set of order terms measured by a measuring system that measures aberration components of said second set of order terms, calculating a third wave-front by correcting said second wave-front based on said first wave-front and calculating corrected aberration components of said second set of order terms, based on said third wave-front and a model for said measuring system.

In the wave-front aberration measuring method according to this invention, measuring aberration components of said second set of order terms may comprise forming a plurality of pattern images by dividing by use of a predetermined optical system a wave-front of light having passed through said optical system; and calculating aberration components of said second set of order terms, based on positions of said plurality of pattern images formed.

In the wave-front aberration measuring method according to this invention, measuring aberration components of said second set of order terms may comprise imaging, after placing at the object plane of said optical system a plurality of divided pattern areas on each of which a pattern that produces light passing through a respective area of a plurality of areas on the pupil plane of said optical system is formed, said patterns formed on said plurality of divided pattern areas through said optical system; and calculating aberration components of said second set of order terms, based on positions of images of said pattern, formed by said optical system.

According to a second aspect of the present invention, there is provided a wave-front aberration measuring unit which measures a wave-front aberration in an optical system subject to measurement, said measuring unit comprising a storage unit that stores calculated correction information for aberration components of a second set of order terms based on a predetermined order term's aberration component out of aberration components of a first set of order terms measured before out of aberration components of order terms of a predetermined basis in which the wave-front aberration in said optical system is expanded; a measuring system that measures aberration components of said second set of order terms of the wave-front aberration in said optical system; and a correcting unit that corrects the measuring result of said measuring system with said correction information.

According to this, a correcting unit corrects aberration components of a second set of order terms measured by a measuring system with calculated correction information for aberration components of the second set of order terms based on a predetermined order term's aberration component out of aberration components of a first set of order terms measured before. That is, the wave-front aberration measuring unit of this invention measures the wave-front aberration in the optical system using the wave-front aberration measuring method, so that the wave-front aberration can be accurately measured.

In the wave-front aberration measuring unit according to this invention, the expansion in said predetermined basis may be an expansion in a set of fringe Zernike polynomials.

Further, in the wave-front aberration measuring unit according to this invention, said measuring system may comprise a wave-front dividing device that divides a wave-front of light having passed through said optical system to form a plurality of pattern images; and an aberration-component calculating unit that calculates aberration components of said second set of order terms, based on positions of said plurality of pattern images formed.

Here, said wave-front dividing device may be a micro-lens array where lens elements are arranged in a matrix.

Yet further, said measuring system may comprise a pattern-formed member that is placed on the object plane's side of said optical system and has a plurality of divided pattern areas on each of which a pattern that produces light passing through a respective area of a plurality of areas on the pupil plane of said optical system is formed; and an aberration-component calculating unit that calculates aberration components of said second set of order terms, based on positions of images of said pattern, formed by said optical system.

According to a third aspect of the present invention, there is provided an exposure apparatus which transfers a given pattern onto a substrate by illuminating said substrate with exposure light, said apparatus comprising an exposure apparatus main body that comprises a projection optical system arranged on the optical path of said exposure light; and a wave-front aberration measuring unit according to this invention with said projection optical system as an optical system subject to measurement.

According to this, a given pattern is transferred onto substrates through a projection optical system whose optical characteristic has been accurately measured by the wave-front aberration measuring unit of this invention and adjusted desirably and securely. Therefore, the given pattern is accurately transferred onto substrates.

According to a fourth aspect of the present invention, there is provided a device manufacturing method including a lithography process, wherein in the lithography process, an exposure apparatus according to this invention performs exposure.

According to this, by performing exposure using the exposure apparatus of this invention, a given pattern is accurately transferred onto divided areas on a substrate, so that the productivity of highly integrated devices having a fine circuit pattern thereon can be improved.

According to a fifth aspect of the present invention, there is provided a device manufactured according to the device manufacturing method of this invention.

### BRIEF DESCRIPTION OF THE DRAWINGS

In the accompanying drawings:

FIG. 1 is a schematic view showing the construction and arrangement of an exposure apparatus according to an embodiment;

FIG. 2 is a schematic view showing the construction of a wave-front sensor in FIG. 1;

FIG. 3 is a view for explaining the surface state of a mark plate in FIG. 2;

FIGS. 4A and 4B are views showing the construction of a micro lens array in FIG. 2;

FIG. 5 is a block diagram showing the construction of a main control system of a wave-front-data processing unit in FIG. 1;

FIG. 6 is a flow chart for explaining the process for obtaining correction information;

FIG. 7 is a flow chart for explaining the exposure process by the apparatus of FIG. 1;

FIG. 8 is a flow chart for explaining the process in an aberration measuring subroutine of FIG. 7;

FIG. 9 is a view showing an exemplary measurement pattern formed on a measurement reticle;

FIG. 10 is a view for explaining an optical arrangement in measuring wave front aberration in the apparatus of FIG. 1;

FIG. 11 is a schematic, oblique view of a measurement reticle in a modified example;

FIG. 12 is a schematic view showing an X-Z cross-section, near the optical axis AX, of the measurement reticle mounted on a reticle stage along with a projection optical system, in the modified example;

FIG. 13 is a schematic view showing an X-Z cross-section of the -Y direction end of the measurement reticle mounted on a reticle stage along with the projection optical system, in the modified example;

FIG. 14A is a view showing a measurement pattern formed on the measurement reticle in the modified example;

FIG. 14B is a view showing a reference pattern formed on the measurement reticle in the modified example;

FIG. 15A is a view showing one of reduced images (latent images) of the measurement pattern formed a given distance apart from each other on the resist layer on a wafer, in the modified example;

FIG. 15B is a view showing the positional relation between the latent image in FIG. 15A of the measurement pattern and the latent image of the reference pattern;

FIG. 16 is a flow chart for explaining the method of manufacturing devices using the exposure apparatus shown in FIG. 1; and

FIG. 17 is a flow chart showing the process in the wafer process step of FIG. 16.

### DETAILED DESCRIPTION OF THE PREFERRED EMBODIMENTS

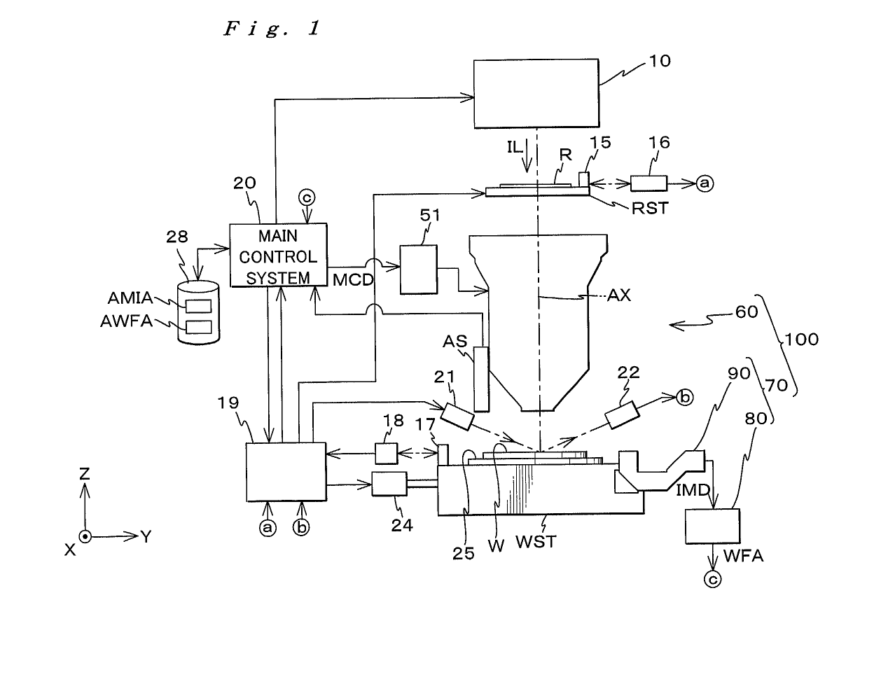

An embodiment of the present invention will be described below with reference to FIGS. 1 to 10.

FIG. 1 shows the schematic construction and arrangement of an exposure apparatus 100 according to this embodiment, which is a projection exposure apparatus of a step-and-scan type. This exposure apparatus 100 comprises an exposure-apparatus main body 60 and a wave-front-aberration measuring unit 70.

The exposure-apparatus main body 60 comprises an illumination system 10, a reticle stage RST for holding a reticle R, a projection optical system PL as an optical system to be examined, a wafer stage WST on which a wafer W as a substrate is mounted, an alignment detection system AS, a stage control system 19 for controlling the positions and yaws of the reticle stage RST and the wafer stage WST, a main control system 20 to control the whole apparatus overall and the like.

The illumination system 10 comprises a light source, an illuminance-uniformalizing optical system including a fly-eye lens and the like, a relay lens, a variable ND filter, a reticle blind, a dichroic mirror, and the like (none are shown). The construction of such an illumination system is disclosed in, for example, Japanese Patent Laid-Open No. 10-112433 and U.S. Pat. No. 6,308,013 corresponding thereto. The disclosure in the above Japanese Patent Laid-Open and U.S. patent is incorporated herein by reference as long as the national laws in designated states or elected states, to which this international application is applied, permit. The illumination system 10 illuminates a slit-like illumination area defined by the reticle blind BL on the reticle R having a circuit pattern thereon with exposure light IL having almost uniform illuminance.

On the reticle stage RST, a reticle R is fixed by, e.g., vacuum chuck. The retilce stage RST can be finely driven on an X-Y plane perpendicular to the optical axis (coinciding with the optical axis AX of a projection optical system PL) of the illumination system 10 by a reticle-stage-driving portion (not shown) constituted by a magnetic-levitation-type, two-dimensional linear actuator in order to position the reticle R, and can be driven at specified scanning speed in a predetermined scanning direction (herein, parallel to a Y-direction). Furthermore, in the present embodiment, because the magnetic-levitation-type, two-dimensional linear actuator comprises a Z-driving coil as well as a X-driving coil and a Y-driving coil, the reticle stage RST can be driven in a Z-direction.

The position of the reticle stage RST in the plane where the stage moves is always detected through a movable mirror 15 by a reticle laser interferometer 16 (hereinafter, referred to as a “reticle interferometer”) with resolving power of, e.g., 0.5 to 1 nm. The position information (or speed information) of the reticle stage RST is sent from the reticle interferometer 16 through the stage control system 19 to the main control system 20, and the main control system 20 drives the reticle stage RST via the stage control system 19 and the reticle-stage-driving portion (not shown) based on the position information (or speed information) of the reticle stage RST.

The projection optical system PL is arranged underneath the reticle stage RST in FIG. 1, whose optical axis AX is parallel to be the Z-axis direction, and is, for example, a reduction optical system that is telecentric bilaterally and that comprises a plurality of lens elements (not shown) whose optical axis AX is parallel to the Z-axis. Moreover, the projection optical system PL has a predetermined reduction ratio β of, e.g. 1/4, 1/5, or ⅙. Therefore, when the illumination area of the reticle R is illuminated with the exposure illumination light IL, the image reduced to the reduction ratio β times the size of the circuit pattern's part in the illumination area on the reticle R is projected and transferred onto a slit-like exposure area of the wafer W coated with a resist (photosensitive material) via the projection optical system PL, the reduced image being a partially inverted image.

It is noted that in this embodiment, specific lens elements, e.g. predetermined five lens elements, of the plurality of lens elements are movable independently of each other. The movement of each of such specific lens elements is performed by three driving devices such as piezo devices, provided on the lens element, which support a lens-supporting member supporting the lens element and which connect the lens element to the lens barrel. That is, the specific lens elements can be moved independently of each other and parallel to the optical axis AX by the displacement of driving devices and can be tilted at a given angle to a plane perpendicular to the optical axis AX. And an imaging-characteristic correcting controller 51 controls drive signals applied to the driving devices according to an instruction MCD from the main control system 20, which signals control the respective displacement amounts of the driving devices.

In the projection optical system PL having the above construction, the main control system 20, by controlling the movement of the lens elements via the imaging-characteristic correcting controller 51, adjusts the optical characteristics such as distortion, field curvature, astigmatism, coma and spherical aberration.

The wafer stage WST is arranged on a base (not shown) below the projection optical system in FIG. 1, and on the wafer stage WST a wafer holder 25 is disposed on which a wafer W is fixed by, e.g., vacuum chuck. The wafer holder 25 is constructed to be able to be tilted in any direction with respect to a plane perpendicular to the optical axis of the projection optical system PL and to be able to be finely moved in the direction of the optical axis AX (the Z-direction) of the projection optical system PL by a driving portion (not shown). The wafer holder 25 can also rotate finely about the optical axis AX.

Furthermore, on the side in the +Y direction of the wafer stage WST, a bracket structure is formed to which a wave front sensor 90 described later is attachable.

The wafer stage WST is constructed to be able to move not only in the scanning direction (the Y-direction) but also in a direction perpendicular to the scanning direction (the X-direction) so that a plurality of shot areas on the wafer can be positioned at an exposure area conjugated to the illumination area, and a step-and-scan operation is performed in which the operation of performing scanning-exposure of a shot area on the wafer and the operation of moving a next shot area to the exposure starting position are repeated. And the wafer stage WST is driven in the X- and Y-directions by a wafer-stage driving portion 24 comprising a motor, etc.

The position of the wafer stage WST in the X-Y plane is always detected through a movable mirror 17 by a wafer laser interferometer with resolving power of, e.g., 0.5 to 1 nm. The position information (or speed information) of the wafer stage WST is sent through the stage control system 19 to the main control system 20, and based on the position information (or speed information), the main control system 20 controls the movement of the wafer stage WST via the stage control system 19 and wafer-stage driving portion 24.

In this embodiment, the alignment detection system AS is a microscope of an off-axis type which is provided on the side face of the projection optical system PL and which comprises an imaging-alignment sensor observing street-lines and position detection marks (fine-alignment marks) formed on the wafer. The construction of such an alignment detection system is disclosed in detail in, for example, Japanese Patent Laid-Open No. 9-219354 and U.S. Pat. No. 5,859,707 corresponding thereto. The disclosure in the above Japanese Patent Laid-Open and U.S. patent is incorporated herein by reference as long as the national laws in designated states or elected states, to which this international application is applied, permit. The alignment detection system AS supplies observation results to the main control system 20.

Furthermore, in the apparatus of FIG. 1, a multi-focus-position detection system (21, 22) is provided which detects positions in the Z-direction (optical axis direction) of areas within and around the exposure area of the surface of the wafer W and which is a focus detection system of an oblique-incidence type. The multi-focal detection system (21, 22) comprises a illumination optical system 21 and a light-receiving optical system 22. The construction of such a multi-focal detection system is disclosed in detail in, for example, Japanese Patent Laid-Open No. 6-283403 and U.S. Pat. No. 5,448,332 corresponding thereto. The disclosure in the above Japanese Patent Laid-Open and U.S. patent is incorporated herein by reference as long as the national laws in designated states or elected states, to which this international application is applied, permit. The multi-focal detection system (21, 22) supplies detection results to the stage control system 19.

The control system includes the main control system 20 in FIG. 1 which is constituted by a work station (or microcomputer) comprising a CPU (Central Processing Unit), ROM (Read Only Memory), RAM (Random Access Memory), etc., and which controls the entire exposure apparatus 100 overall as well as the above operations. The main control system 20 controls between-shots stepping of the wafer stage, exposure timing and the like overall to perform exposure securely.

In addition, the storage unit 28 constituted by, e.g., a hard disk is connected to the main control system 20, and comprises a correction-information store area AMIA for storing correction-information AMI for correcting the result of measuring the wave front aberration by the wave-front-aberration measuring unit 70 described later and a corrected-wave-front-aberration data store area AWFA for storing wave-front-aberration data AWF corrected using the correction-information AMI, the wave-front-aberration data AWF and correction-information AMI being described later.

The wave-front-aberration measuring unit 70 comprises a wave-front sensor 90 and a wave-front-data processing unit 80.

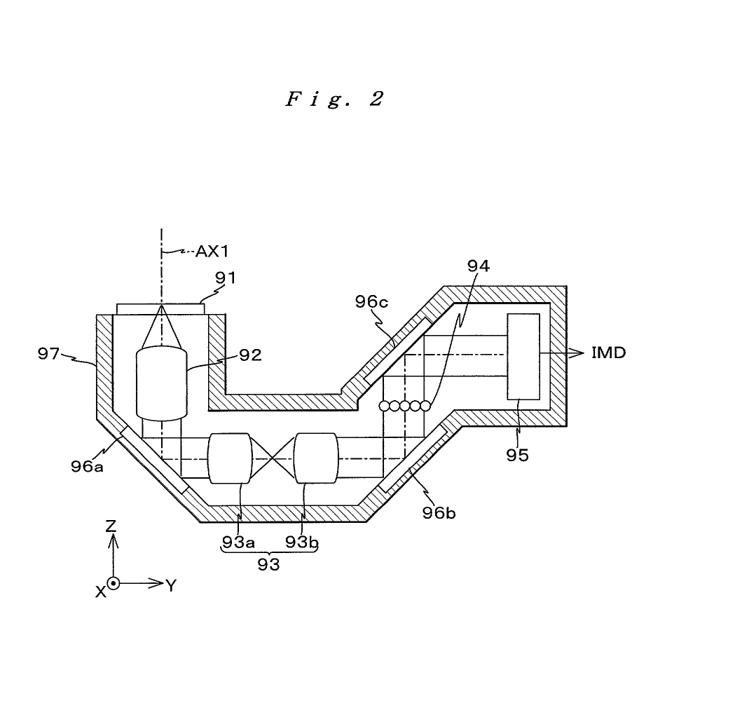

The wave-front sensor 90, as shown in FIG. 2, comprises a mark plate 91, a collimator lens 92, a relay lens system 93 composed of lenses 93a and 93b, a micro-lens array 94 as a device for dividing wave-fronts, and a CCD 95 as an image-picking-up unit, which are arranged sequentially in that order on the optical axis AX1. Moreover, the wave-front sensor 90 further comprises mirrors 96a, 96b, 96c for setting the optical path of light incident on the wave-front sensor 90, and a housing member 97 housing the collimator lens 92, the relay lens system 93, the micro-lens array 94, the CCD 95 and the mirrors 96a, 96b, 96c.

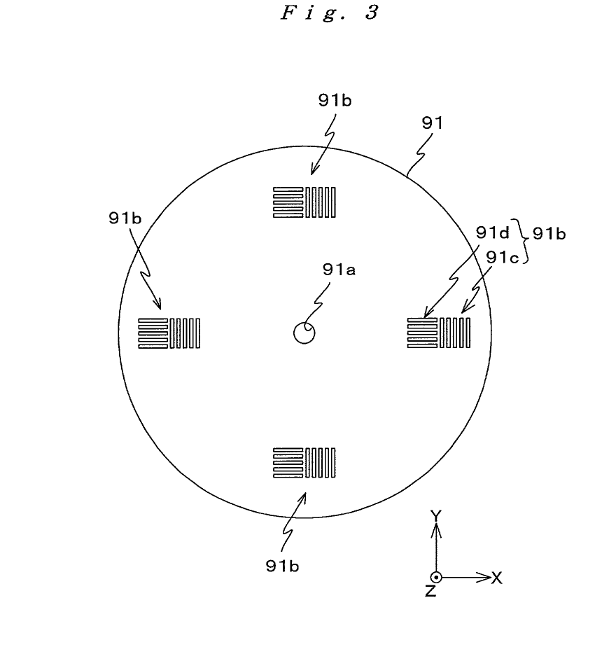

The mark plate 91 is made using a glass substrate as the substrate and is disposed such that the position in the Z-direction thereof is the same as the surface of the wafer W fixed on the wafer holder 25 while the surface thereof is perpendicular to the optical axis AX1 (refer to FIG. 2). An opening 91a is made in the center of the mark plate 91 as shown in FIG. 3. Furthermore, formed around the opening 91a on the surface of the mark plate 91 are more than two, four in FIG. 3, two-dimensional position-detection marks 91b. In this embodiment, the two-dimensional position-detection mark 91b comprises a line-and-space mark 91c having lines extending in the X-direction and a line-and-space mark 91d having lines extending in the Y-direction. It is remarked that the line-and-space marks 91c, 91d can be observed by the above alignment detection system AS. Moreover, the other part of the surface of the mark plate 91 than the opening 91a and the two-dimensional position-detection mark 91b is made reflective by, for example, depositing chrome (Cr) on the glass substrate.

Referring back to FIG. 2, the collimator lens 92 produces parallel rays of light from light incident through the opening 91a.

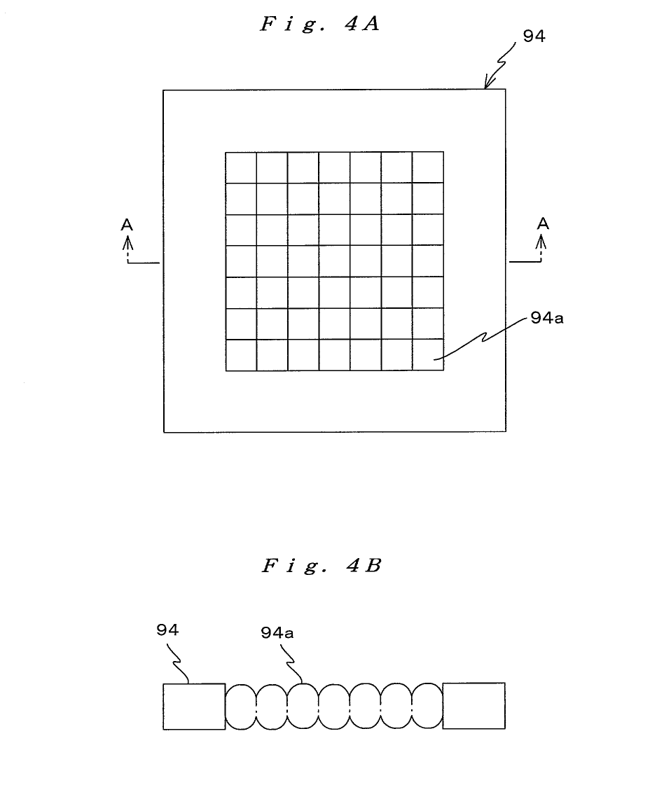

The micro-lens array 94, as shown in FIGS. 4A and 4B, has a lot of micro lenses 94a having a positive refractive power, which are square in the plan view, which are arranged in a matrix and adjacent to each other, and whose optical axes are substantially parallel to each other. It is remarked that FIG. 4 shows micro lenses 94a arranged in a matrix with 7 rows and 7 columns as an example. The micro-lens array 94 is made by etching a plane parallel plate, and each micro lens 94a of the micro-lens array 94 focuses rays of light incident through the relay lens system 93 and images the image on the opening 91a in a respective position.

The optical system comprising the collimator lens 92, the relay lens system 93, the micro-lens array 94 and the mirrors 96a, 96b, 96c is called a wave-front-aberration measuring optical system, hereinafter.

The CCD 95 is disposed a predetermined distance apart from the micro-lens array 94, specifically on an image plane on which images are formed by the micro lenses 94a, the images being formed from the image on the opening 91a. That is, the CCD 95 has a light-receiving plane conjugate to the plane where the opening 91a of the wave-front-aberration measuring optical system is made, and picks up the lot of images formed on the light-receiving plane from the image on the opening 91a. The pick-up result as pick-up data IMD is supplied to the wave-front-data processing unit 80.

The housing member 97 has supporting members (not shown) for supporting the collimator lens 92, the relay lens system 93, the micro-lens array 94 and the CCD 95 respectively. It is remarked that the reflection mirrors 96a, 96b, 96c are fixed to the inner surface of the housing member 97. Furthermore, the housing member 97 has such an outer shape that it is fitted into the bracket structure of the wafer stage WST and is attachable to and detachable from the wafer stage WST.

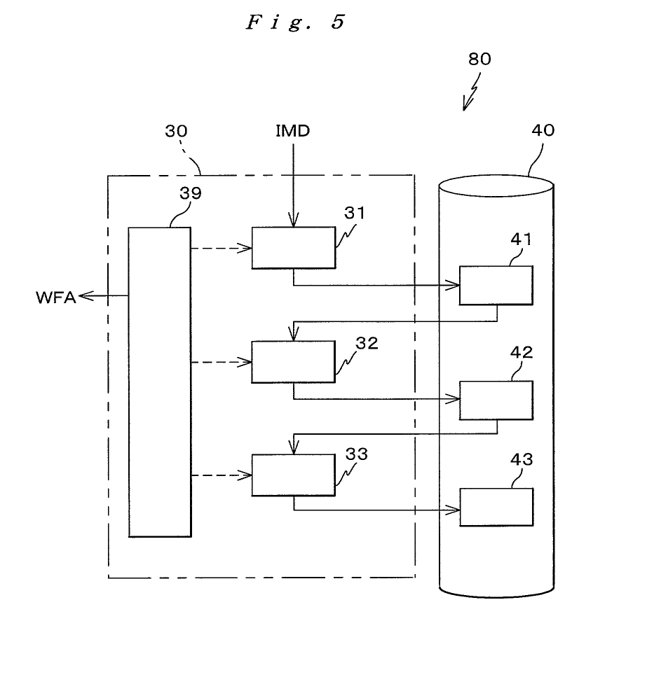

The wave-front-data processing unit 80 comprises a main controller 30 and a storage unit 40 as shown in FIG. 5. The main controller 30 comprises (a) a controller 39 for controlling the overall action of the wave-front-data processing unit 80 and supplying wave-front measurement result data WFA to the main control system 20, (b) a pick-up data collecting unit 31 for collecting pick-up data IMD from the wave-front sensor 90, (c) a position-detecting unit 32 for detecting the positions of spot-images based on the pick-up data and (d) a wave-front-aberration calculating unit 33 for calculating the wave-front aberration of the projection optical system PL.

In addition, the storage unit 40 comprises (a) a pick-up data store area 41 for storing pick-up data, (b) a spot-image-position store area 42 for storing spot-image position data, and (c) a wave-front-aberration-data store area 43 for storing wave-front-aberration data.

While, in this embodiment, the main controller 30 comprises the various units as described above, the main controller 30 may be a computer system where the functions of the various units are implemented as program modules installed therein.

Next, the measurement of the wave-front-aberration in the projection optical system PL and the exposure operation will be described. In the below description, the wave-front-aberration measuring unit 70 measures aberration components (coefficients Z₂ through Z_{M} in the above equation (1)) of the second through M'th (e.g. M=36) order terms when the wave-front aberration is expanded in terms of fringe Zernike polynomials. And the word “order” means the order associated with each term of the wave-front aberration expanded in terms of fringe Zernike polynomials. Furthermore, it is assumed that the precise, mathematical model for the wave-front sensor 90 of the wave-front-aberration measuring unit 70 is known.

Yet further, it is assumed that aberration components of (M+1)'th order and over hardly vary between before and after installing the projection optical system PL in the exposure apparatus 100, which assumption is, from experience, known to be correct. Moreover, it is assumed that the result of measuring the wave-front aberration not having components of (M+1)'th order and over hardly varies between upon very accurate measurement and when using the wave-front-aberration measuring unit 70.

First, correction-information AMI stored in the correction-information store area AMIA of the storage unit 28 in FIG. 1 will be described which is obtained before the wave-front-aberration measuring unit 70 measuring the wave-front aberration in the following manner.

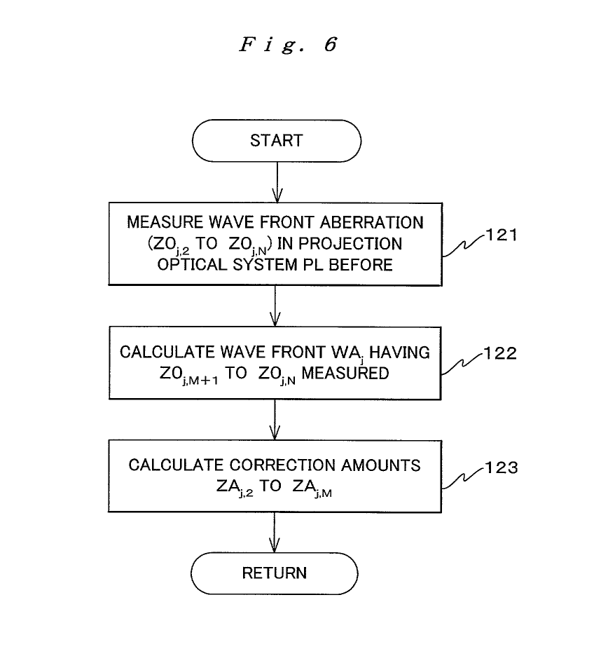

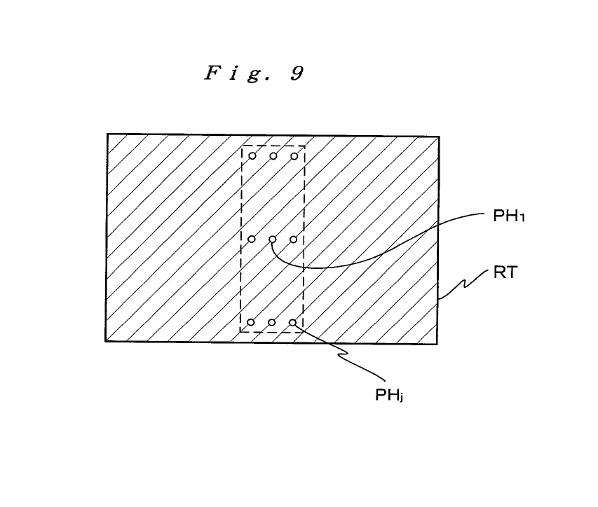

First, in a step 121 of FIG. 6, for the position (image height) of each of pinhole features PHⱼ (j=1 through J) (refer to FIG. 9) of a measurement reticle RT described later, aberration components Z0_{j,2} through Z0_{j,N} (corresponding to coefficients Z₂ through Z_{N} in the above equation (1)) of the second through N'th (N>M) order terms when the wave-front aberration in the projection optical system PL is expanded in terms of fringe Zernike polynomials are measured. This measurement is performed when making the projection optical system PL before installing the projection optical system PL in the exposure apparatus 100. Therefore, it is possible to spend much time and much of measurement resources on the measurement, so that the wave-front aberration in the projection optical system PL is very accurately measured. Incidentally, a Fizeau interferometer, etc., is used in the measurement.

In the actual making of the projection optical system PL, measuring the aberration components of the second through N'th order terms and, based on the measuring result, adjusting for the wave-front aberration are repeated, so that the wave-front aberration characteristic of the projection optical system PL is finally adjusted to be a desired one. The aberration components Z0_{j,2} through Z0_{j,N} measured in the step 121 and used in later steps are ones after the final adjustment. Aberration components of higher than N'th order terms exist in practice, but are assumed to be negligible. For example, in the case of lenses usually used in the projection optical system PL, because of their shape, aberration components of higher order terms than the highest order term of the wave-front aberration measured in the making of the projection optical system PL are small enough for the assumption to be true.

Next, in a step 122, with letting aberration components Z0_{j,2} through Z0_{j,M} of the aberration components Z0_{j,2} through Z0_{j,N} measured in the step 121 be zero, a higher-order aberration wave-front WAⱼ having only aberration components Z0_{j,M+1} through Z0_{j,N} is calculated which is expressed by the expression (2).

$${WA}_{j} ( ρ , θ ) = {\sum }_{i = M + 1}^{N} \{ Z {0}_{j , i} \cdot {f}_{i} ( ρ , θ ) \} \qquad ( 2 )$$

Next, in a step 123, the second through M'th order aberration components ZA_{j,2} through ZA_{j,M} are calculated by a simulation based on the higher-order aberration wave-front WAⱼ and a mathematical model of the wave-front sensor 90, which would be obtained by the wave-front-aberration measuring unit 70 measuring the higher-order aberration wave-front WAⱼ. The aberration components ZA_{j,2} through ZA_{j,M} calculated represent amounts by which the aliasing, etc., cause the (M+1)'th through N'th order aberration components to blend into the second through M'th order components. The aberration components ZA_{j,2} through ZA_{j,M} calculated are stored as correction-information AMI in the correction-information store area AMIA of the storage unit 28 via a communication line or storage medium.

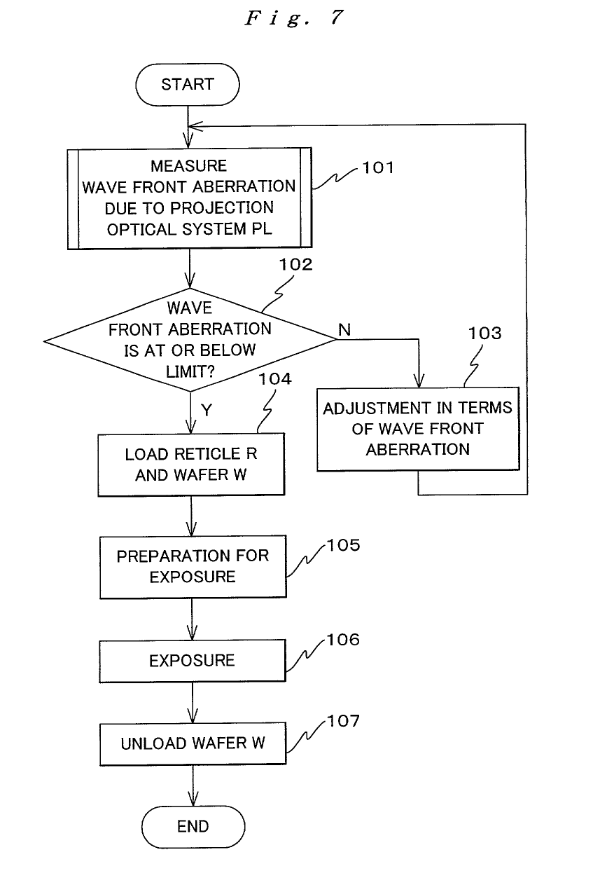

Next, the operation of measuring the wave-front aberration and exposure operation by the exposure apparatus 100 of this embodiment will be described with reference to a flow chart in FIG. 7 and other figures as needed. It is remarked that measuring the wave-front aberration as described below is performed upon inspection when installing the exposure apparatus 100 and periodic maintenances.

As a premise of the operation it is assumed that the wave-front sensor 90 is mounted on the wafer stage WST and that the wave-front-data processing unit 80 is connected to the main control system 20.

Moreover, it is assumed that the positional relation between the opening 91a of the mark plate 91 of the wave-front sensor 90 fixed to the wafer stage and the wafer stage WST has been measured by observing the two-dimensional position-detection marks 91b through the alignment detection system AS. That is, the assumption is that the X-Y position of the opening 91a can be accurately detected based on position information (or speed information) from a wafer interferometer 18, and that by controlling the movement of the wafer stage WST via the wafer-stage driving portion 24, the opening 91a can be accurately positioned at a desired X-Y position. In this embodiment, the positional relation between the opening 91a and the wafer stage WST is accurately detected, based on detection result of the positions of the four two-dimensional position-detection marks 91b through the alignment detection system AS, using a statistical method such as EGA (Enhanced Global Alignment) disclosed in, for example, Japanese Patent Laid-Open No. 61-44429 and U.S. Pat. No. 4,780,617 corresponding thereto. The disclosure in the above Japanese Patent Laid-Open and U.S. patent is incorporated herein by reference as long as the national laws in designated states or elected states, to which this international application is applied, permit.

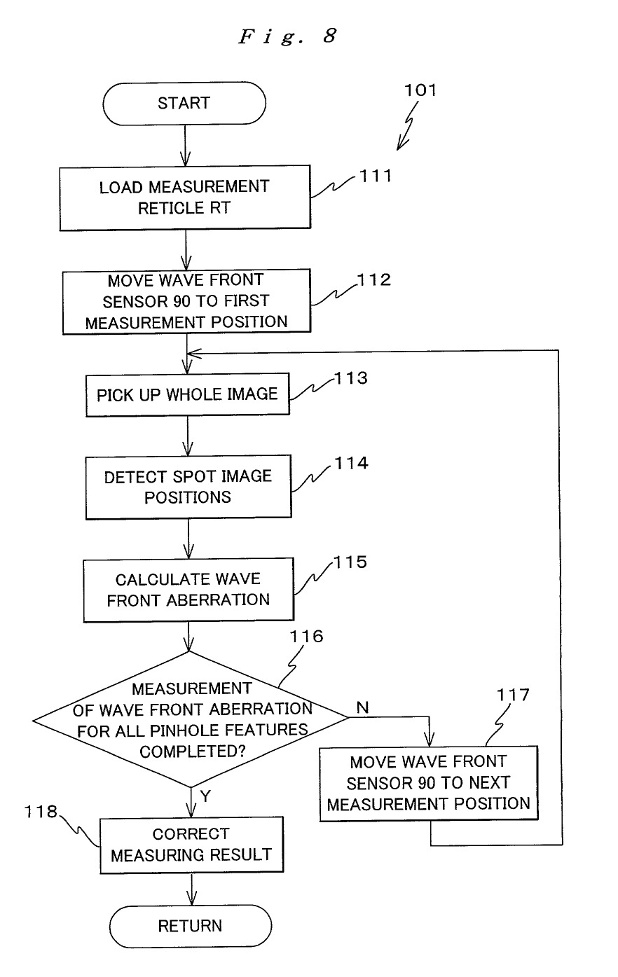

In the process shown in FIG. 7, first in a subroutine 101, the wave-front aberration of the projection optical system PL is measured. In a step 111 of the measuring of the wave-front aberration, as shown in FIG. 8, a reticle loader (not shown) loads a measurement reticle RT, shown in FIG. 9, for measuring the wave-front aberration onto the reticle stage RST. FIG. 9 shows the measurement reticle RT on which a plurality of pinhole-like features PHj (j=1 through J; J=9 in FIG. 9) are formed in a matrix arrangement, whose rows are parallel to the Y-direction and whose columns are parallel to the X-direction. It is noted that the pinhole-like features PH₁ through PHⱼ are formed within an area having the size of the slit-like illumination area, which is enclosed by dashed lines in FIG. 9.

Subsequently, reticle alignment using a reference mark plate (not shown) fixed on the wafer stage WST and measurement of base-line amount through the alignment detection system AS are performed. And the reticle stage RST is moved for measuring the wave-front aberration such that the first pinhole-like feature PH₁ is positioned on the optical axis AX of the projection optical system PL, which movement the main control system 20 controls via the stage control system 19 and the reticle-stage driving portion based on position information (or speed information) of the reticle stage RST from the reticle interferometer 16.

Referring back to FIG. 8, in a step 112 the wafer stage WST is moved so that the opening 91a of the mark plate 91 of the wave-front sensor 90 is positioned at a position conjugate to the pinhole-like feature PH₁ with respect to the projection optical system PL, which position is on the optical axis AX. The main control system 20 controls such movement via the stage control system 19 and the wafer-stage driving portion 24 based on position information (or speed information) of the wafer stage WST from a wafer interferometer 18. The main control system 20 drives the wafer stage WST finely in the Z-direction via the wafer-stage driving portion 24 based on the detection result from the multi-focal detection system (21, 22) so that the image plane on which the pinhole-like feature PH₁ is imaged coincides with the upper surface of the mark plate 91 of the wave-front sensor 90.

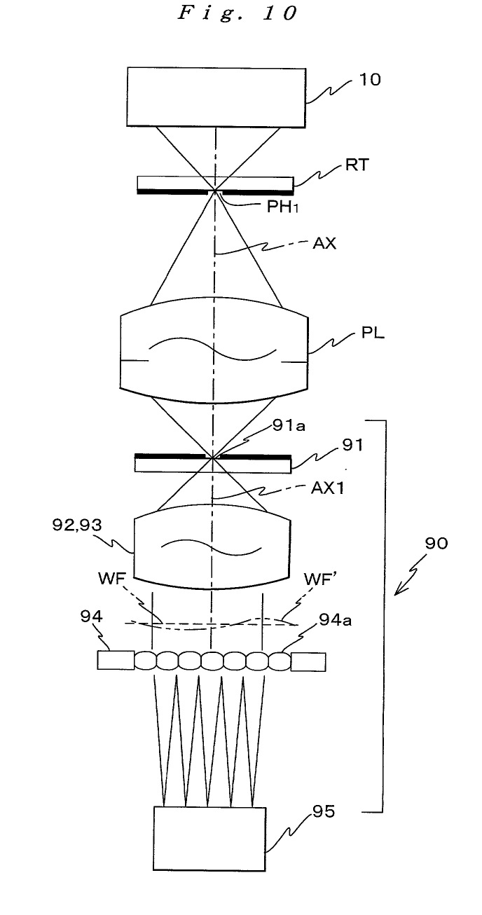

By this, positioning of components for measuring the wave-front aberration using a spherical wave from the first pinhole-like feature PH₁ is completed. FIG. 10 shows the optical arrangement of the components with centering the optical axis AX1 of the wave-front sensor 90 and the optical axis AX of the projection optical system PL in the drawing.

In this optical arrangement, the illumination light IL from the illumination system 10 reaches the first pinhole-like feature PH₁ on the measurement reticle RT, which sends out the light being a spherical wave. The spherical wave is focused on the opening 91a of the mark plate 91 of the wave-front sensor 90 through the projection optical system PL. It is remarked that light passing through the pinhole-like features PH₂ through PH_{N} other than the first pinhole-like feature PH₁ do not reach the opening 91a. The wave front of the light focused on the opening 91a is almost spherical with wave-front aberration due to the projection optical system PL.

It is noted that the measurement result of the wave-front aberration obtained by the wave-front-aberration measuring unit 70 may include components due to position deviation of the upper surface of the mark plate 91 of the wave-front sensor 90 from the image plane of the projection optical system PL, on which a pinhole image of the pinhole-like feature PH₁ is formed, as well as the wave-front aberration due to the projection optical system PL, which components are caused by tilt, position deviation in the optical-axis direction and so forth. Therefore, the position of the wafer stage WST is controlled based on the deviation components calculated based on wave-front-aberration data obtained by the wave-front-aberration measuring unit 70, so that very accurate wave-front-aberration measurement is possible.

The collimator lens 92 produces from the light having passed through the opening 91a parallel rays of light, which is made incident on the micro-lens array 94 via the relay lens system 93. Here, the wave-front of the light incident on the micro-lens array 94 has wave-front aberration due to the projection optical system PL. That is, while if the projection optical system PL does not cause wave-front aberration, the wave-front WF is, as shown by a dashed line in FIG. 10, a plane perpendicular to the optical axis AX1, if the projection optical system PL causes wave-front aberration, the wave-front WF′ varies in gradient according to position as shown by a two-dot chain line in FIG. 10.

In the micro-lens array 94, each micro lens 94a images the image of the pinhole-like feature PH₁ on the opening 91a on the pick-up plane of CCD 95 conjugate to the mark plate 91. If the wave-front of the light incident on the micro lens 94a is perpendicular to the optical axis AX1, the spot-image centered at the intersection point of the micro lens 94a 's optical axis and the image plane is formed on the image plane. If the wave-front of the light incident on the micro lens 94a is oblique to the optical axis AX1, the spot-image centered at a point a distance apart from the intersection point of the micro lens 94a 's optical axis and the image plane is formed on the image plane, the distance varying according to the gradient of the wave-front.

Referring back to FIG. 8, in a step 113 the CCD 95 picks up an image formed on the image plane, from which pick-up data IMD is obtained and supplied to the wave-front-data processing unit 80. In the wave-front-data processing unit 80, the pick-up data collecting unit 31 collects the pick-up data IMD and stores in the pick-up data store area 41.

Next, in a step 114, the spot-image position detecting unit 32 reads out the pick-up data from the pick-up data store area 41, detects spot-image positions based on the pick-up data, and stores them in the spot-image position store area 42.

Subsequently, in the step 115 the wave-front-aberration calculating unit 33 reads out the detection result of the spot image positions from the position data store area 42 and calculates the aberration components (coefficients) ZM_{1,2} through ZM_{1,M} of the second through M'th order terms of the wave-front-aberration of light through the first pinhole-like feature PH₁ of the measurement reticle RT due to the projection optical system PL. The aberration components ZM_{1,2} through ZM_{1,M} are calculated as coefficients of fringe Zernike polynomials based on the differences between spot image positions expected if no wave-front-aberration exists and the spot image positions detected. Because the method of calculating aberration components is known, the description thereof is omitted.

The wave-front-aberration calculating unit 33 stores the calculated aberration components ZM_{1,2} through ZM_{1,M} as a result of measuring the wave-front aberration together with the position data of the pinhole-like feature PH₁ in the wave-front-aberration-data store area 43.

Next, a step 116 checks whether or not the wave-front-aberration due to the projection optical system PL for all the pinhole-like features have been calculated. Because at this point of time only that for the first pinhole-like feature PH₁ has been calculated, the answer is NO, and the process proceeds to a step 117.

In the step 117 the wafer stage WST is moved so that the opening 91a of the mark plate 91 of the wave-front sensor 90 is positioned at a position conjugate to the pinhole-like feature PH₂ with respect to the projection optical system PL. The main control system 20 controls such movement via the stage control system 19 and the wafer-stage driving portion 24 based on position information (or speed information) of the wafer stage WST from the wafer interferometer 18. Also in this case, the main control system 20 drives the wafer stage WST finely in the Z-direction via the wafer-stage driving portion 24 based on a detection result from the multi-focal detection system (21, 22) so that the image plane on which the pinhole-like feature PH₂ is imaged coincides with the upper surface of the mark plate 91 of the wave-front sensor 90.

Also when moving the upper surface of the mark plate 91 of the wave-front sensor 90 to the image plane on which an image of the pinhole-like feature PH₂ is formed, the position of the wafer stage WST is, as described above, controlled based on the above position-deviation components calculated based on wave-front-aberration data obtained by the wave-front-aberration measuring unit 70, which control is preferably performed for each pinhole-like feature.

And aberration components ZM_{2,2} through ZM_{2,M} of the projection optical system PL are measured in the same way as for the pinhole-like feature PH₁, and the aberration components ZM_{2,2} through ZM_{2,M} are stored together with the position data of the pinhole-like feature PH₂ in the wave-front-aberration-data store area 44.

After that, the wave-front-aberrations due to the projection optical system PL for all the pinhole-like features are sequentially measured likewise and stored together with data of the pinhole-like feature' positions in the wave-front-aberration-data store area 44. When the aberration components ZM_{j,2} through ZM_{j,m} (j=1 through J) of the projection optical system PL for all the pinhole-like features have been measured, the answer in the step 116 is YES. And the controller 39 reads out the measurement results ZM_{j,2} through ZM_{j,M} of the wave-front-aberrations from the wave-front-aberration-data store area 44 and supplies them as wave-front-measurement data WFA to the main control system 20.

Then in a step 118, the main control system 20 reads out the correction-information AMI [ZA_{j,i}] (j=1 through J, i=2 through M) from the storage unit 28, corrects the wave-front-measurement result data WFA [ZM_{j,i}] from the wave-front-data processing unit 80 with the correction-information AMI [ZA_{j,i}] by using the following equation (3) to obtain the wave-front-aberration-measurement result ZF_{j,i}

ZF_{j,i}=ZM_{j,i}−ZA_{j,i.} (3)

The main control system 20 stores the wave-front-aberration-measurement result ZF_{j,i} as wave-front aberration data AWF in the corrected-wave-front-aberation aberration data store area AWFA. By this, the process in the subroutine 101 ends, and the process proceeds to a step 102 in FIG. 7.

In the step 102, the main control system 20 checks based on the wave-front-aberration-measurement result ZF_{j,i} from the wave-front-aberration measuring unit 70 (more exactly the controller 39) whether or not the wave-front-aberrations due to the projection optical system PL are at or below a permissible limit. While, if the answer is YES, the process proceeds to a step 104, if the answer is NO, the process proceeds to a step 103. At this point of time the answer is NO, and the process proceeds to the step 103.

In the step 103, the main control system 20 adjusts the projection optical system PL based on the wave-front-aberration measurement results so as to reduce the wave-front-aberration. In the adjustment the main control system 20 may move the lens elements via the imaging-characteristic correcting controller 51 or, if necessary, the lens elements of the projection optical system PL may be manually moved on the X-Y plane or replaced.

Subsequently, in the subroutine 101 the wave-front-aberrations due to the projection optical system PL adjusted is measured likewise. Until the answer in the step 102 becomes YES, the adjustment of the projection optical system PL in terms of the wave-front-aberration (step 103) and the measurement of the wave-front-aberration (step 101) are repeated. And when the answer in the step 102 becomes YES, the process proceeds to a step 104.

It is remarked that although the process of the subroutine 101 through step 103 is performed usually upon inspection when installing the exposure apparatus 100 and periodic maintenances, it may be each time the wafer, the wafer lot, or the reticle is replaced.

In the step 104, after the wave front sensor 90 has been removed from the wafer stage WST, and the wave-front-data processing unit 80 is disconnected from the main control system 20, a reticle loader (not shown) loads a reticle R having a given pattern formed thereon onto the reticle stage RST under the control of the main control system 20, and a wafer loader (not shown) loads a wafer W subject to exposure onto the wafer stage WST.

Next, in a step 105, measurement for exposure is performed under the control of the main control system 20, such as reticle alignment using a reference mark plate (not shown) on the wafer stage WST and measurement of base-line amount using the alignment detection system AS. When the exposure of the wafer W is for a second or later layer, the arrangement coordinates of shot areas on the wafer W are detected very accurately by the above EGA measurement using the alignment detection system AS so that the layer pattern to be formed can be very accurately aligned with previous layer' pattern already formed thereon.

Next, in a step 106, before exposure the wafer stage WST is moved so that a first shot area on the wafer W is positioned at a scan start position for exposure. The main control system 20 controls such movement via the stage control system 19 and the wafer-stage driving portion 24 based on position information (or speed information) of the wafer stage WST from the wafer interferometer 18 and, if the second or later layer, the detection result of the positional relation between a reference coordinate system and the arrangement coordinate system as well. At the same time the reticle stage RST is moved so that the reticle R is positioned at a scan start position for reticles, via the stage control system 19 and a reticle-stage driving portion (not shown) by the main control system 20.

Next, the stage control system 19, according to instructions from the main control system 20, performs scan exposure while adjusting the position of the wafer W surface based on the Z-direction position information of the wafer W from the multi-focus-position detection system (21, 22), the X-Y position information of the reticle R from the reticle interferometer 16 and the X-Y position information of the wafer W from the wafer interferometer 18 and moving relatively the reticle R and wafer W via the reticle-stage driving portion (not shown) and via the wafer-stage driving portion 24.

After the completion of exposure of the first shot area, the wafer stage WST is moved so that a next shot area is positioned at the scan start position for exposure, and at the same time the reticle stage RST is moved so that the reticle R is positioned at the scan start position for reticles. The scan exposure of the shot area is performed in the same way as the first shot area. After that, the scan exposure is repeated until all shot areas have been exposed.

In a step 107 an unloader (not shown) unloads the exposed wafer W from the wafer holder 25, by which the exposure of the wafer W is completed.

In the exposure of later wafers, the wafer exposure sequence of the steps 104 through 107 is performed with, if necessary, measuring and adjusting wave-front aberration due to the projection optical system PL (steps 101 through 103).

As described above, according to this embodiment, when obtaining the aberration components ZF_{j,i} (i=2 through M) of the second through M'th order terms of the projection optical system PL installed in the exposure apparatus 100, based on the aberration components (coefficients) Z0_{j,M+1} through Z0_{j,N} of the (M+1)'th through N'th (N>M) order terms accurately measured before, the correction amounts ZA_{j,i} are calculated which represent amounts of the aberration components (coefficients) Z0_{j,M+1} through Z0_{j,N} of the (M+1)'th through N'th order terms that blend into the aberration components ZM_{j,i} of the second through M'th order terms measured by the wave-front-aberration measuring unit 70. And the aberration components ZM_{j,i} of the second through M'th order terms measured by the wave-front-aberration measuring unit 70 are corrected with the correction amounts ZA_{j,i} to obtain the aberration components ZF_{j,i}. Therefore, the aberration components ZF_{j,i} of the second through M'th order terms of the wave-front aberration in the projection optical system PL can be accurately obtained.

Furthermore, because the projection optical system PL is adjusted in terms of the wave-front aberration based on the accurately calculated wave-front aberration due to the projection optical system PL, and a given pattern of a reticle R is projected onto a wafer W through the projection optical system PL that causes little aberration, the given pattern can be very accurately transferred on the wafer W.

While in the above embodiment the number of the pinhole-like features of the measurement reticle RT is nine, more or less than nine pinhole-like features may be provided depending on the desired accuracy in measurement of wave-front aberration. Also, the number and arrangement of micro lenses 94a in the micro-lens array 94 can be changed depending on the desired accuracy in measurement of wave-front aberration.

Furthermore, in this embodiment the following method can be adopted in order to improve the measurement accuracy.

That is, in order to reduce the sampling error of the CCD 95, an intensity distribution is calculated with using interpolation process based on data obtained by making the wave-front sensor 90 step in a given direction, e.g., N times by PT/N, where PT indicates the cell size of the CCD 95, which intensity distribution is in a position-resolving power of N times that of an intensity distribution based on data obtained in a usual way without stepping. It is remarked that in order to improve the position-resolving power in two dimensions, the wave-front sensor 90 needs to step in two dimensions.

The method of stepping comprises tilting the wave-front sensor 90 about the opening 91a of the wave-front sensor 90. But not limited to shifting the whole wave-front sensor 90, the micro-lens array 94 or the CCD 95 of the wave-front sensor 90 or both the micro-lens array 94 and the CCD 95 may be shifted in a direction perpendicular to the optical axis of the wave-front-aberration measurement optical system with the other elements fixed in their positions.

In addition, although in the above embodiment the correction amounts ZA_{j,i} represent amounts of the aberration components (coefficients) Z0_{j,M+1} through Z0_{j,N} of the (M+1)'th through N'th order terms that blend into the aberration components ZM_{j,i} of the second through M'th order terms measured by the wave-front-aberration measuring unit 70, instead of the values ZA_{j,i} the higher-order aberration wave-front WAⱼ may be used as the correction-information AMI. In this case, the process by the main control system 20 in the step 118 of FIG. 8 is as follows.

First, the main control system 20 calculates an aberration wave-front WBⱼ in which the second through M'th order term' coefficients are the aberration components ZM_{j,i} respectively, based on the aberration components ZM_{j,i} measured by the wave-front-aberration measuring unit 70. Subsequently, the main control system 20 reads out the higher-order aberration wave-front WAj from the correction-information store area AMIA of the storage unit 28 and calculates a corrected wave-front WCⱼ using the equation (4)

WCⱼ=WBⱼ−WAⱼ. (4)

Next, the main control system 20 calculates based on the corrected wave-front WCⱼ and a mathematical model of the wave-front sensor 90 aberration components ZFⱼ′ that would be obtained when the wave-front-aberration measuring unit 70 measured the corrected wave-front WCⱼ, which components ZF_{j,i}′ are equivalent to the final aberration components ZF_{j,i}, which are obtained in the above embodiment.

Moreover, in the above embodiment when calculating the higher-order aberration wave-front WAⱼ, of the aberration components Z0_{j,2} through Z0_{j,N} the aberration components Z0_{j,M+1} through Z0_{j,N} are used with letting the aberration components Z0_{j,2} through Z0_{j,m} be zero. However, all the aberration components Z0_{j,m+1} through Z0_{j,N} need not be used, and at least one of the aberration components Z0_{j,M+1} through Z0_{j,N} only has to be included when calculating the higher-order aberration wave-front WAⱼ.

The higher-order aberration wave-front WAⱼ may be calculated based on the aberration components Z0_{j,M+1} through Z0_{j,N} with letting one of the aberration components Z0_{j,2} through Z0_{j,M} be non-zero and the rest be zero, in which case the accuracy will decrease.

Furthermore, although in the above embodiment the orders of the aberration components measured by the wave-front-aberration measuring unit 70 are continuous, the orders may be not continuous or intermittent. In this case, the corrected wave-front corresponding to the higher-order aberration wave-front WAⱼ can be calculated using the prior measuring result for aberration components not measured by the wave-front-aberration measuring unit 70.

In addition, although the above embodiment describes the case where after the wave-front-aberration measuring unit 70 measures the wave-front aberration in the projection optical system PL the measuring result is corrected, it is possible to measure the wave-front aberration using a measurement reticle RT′ (hereinafter, called a “reticle RT′” as needed) described in the following and to correct the measuring result in the same way as in the above embodiment. In this modified example the main control system 20 further comprises the function of the wave-front-aberration calculating unit 33.

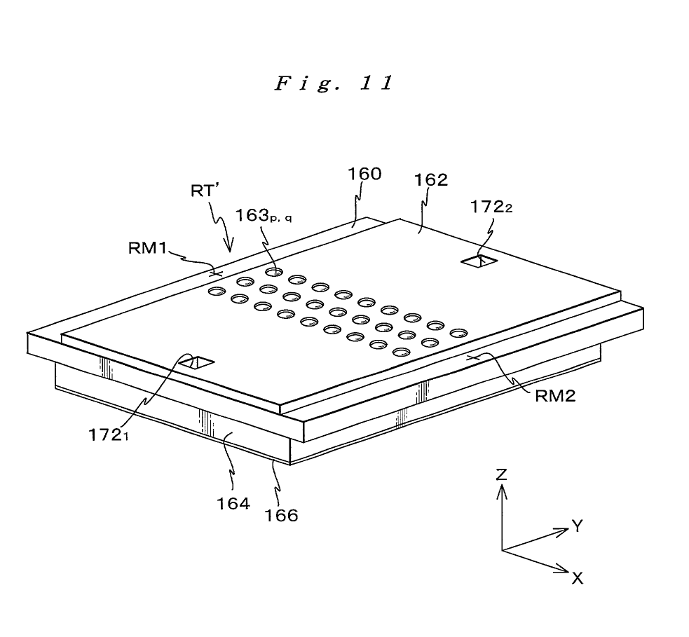

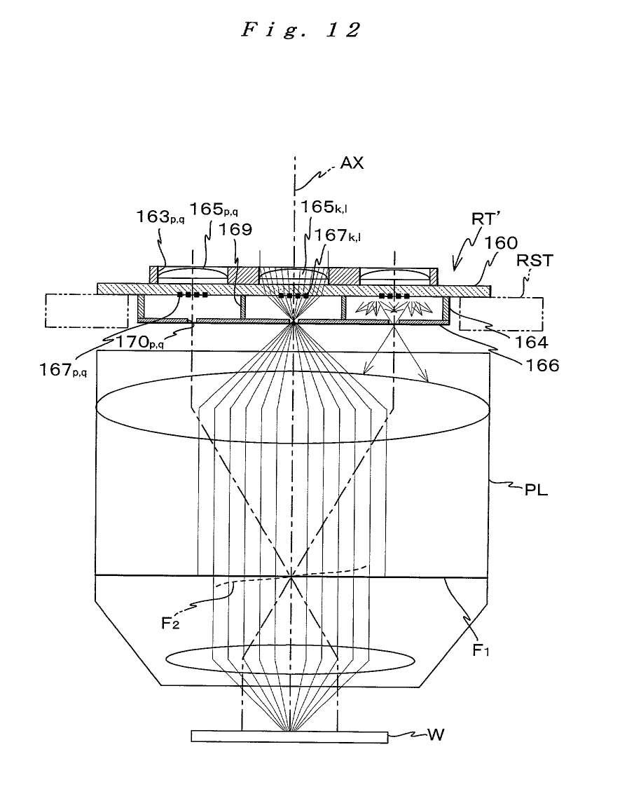

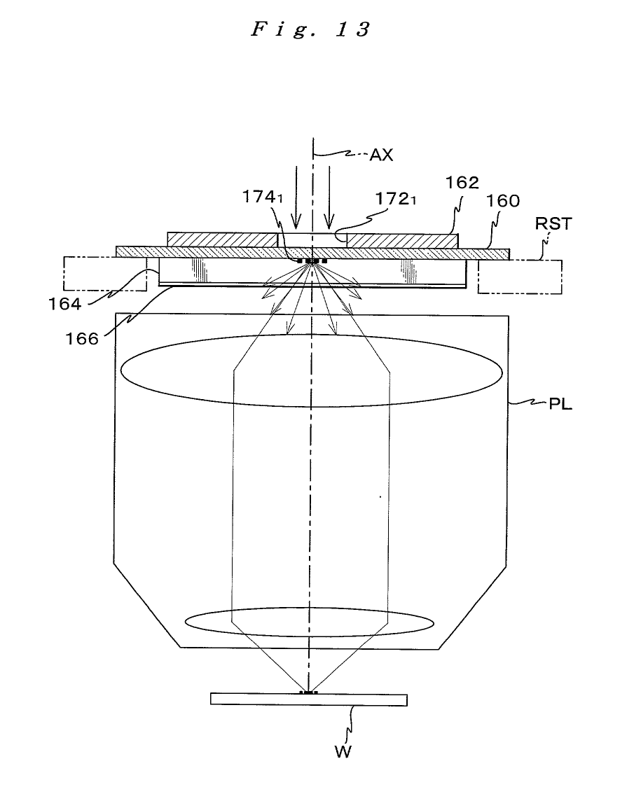

FIG. 11 shows a schematic, oblique view of the measurement reticle RT′; FIG. 12 is a schematic view showing an X-Z cross-section, near the optical axis AX, of the measurement reticle mounted on the reticle stage RST along with the projection optical system PL, and FIG. 13 is a schematic view showing an X-Z cross-section of the -Y direction end of the measurement reticle mounted on the reticle stage along with the projection optical system PL.

As is shown in FIG. 11, the measurement reticle RT has almost the same shape as a usual reticle with a pellicle and comprises a glass substrate 160, a lens-holding member 162 having a rectangular-plate-like shape and which is fixed on the upper surface of the glass substrate 160 in FIG. 11 such that its center coincides with that of the glass substrate 160, a spacer member 164 constituted by a frame member fixed on the bottom surface of the glass substrate 160 and having the same shape as a usual pellicle frame, and an aperture plate 166 fixed on the bottom surface of the spacer member 164.

In the lens-holding member 162, a matrix arrangement of R circular apertures 163_{p,q} (p=1 through P, q=1 through Q, P×Q=R) is formed in a slit-like area, which is the illumination area of illumination light IL. Provided inside of the circular apertures 163_{p,q} are condenser lenses 165_{p,q} each constituted by a convex lens whose optical axis is parallel to the Z-direction (refer to FIG. 12).

Inside the space enclosed by the glass substrate 160, the spacer member 164 and the aperture plate 166, supporting members 169 are arranged spaced a predetermined distance apart from each other as shown in FIG. 12.

Furthermore, measurement patterns 167_{p,q} are formed on the opposite side of the glass substrate 160 to the condenser lenses 165_{p,q} as shown in FIG. 12. Made opposite the measurement patterns 167_{p,q} in the aperture plate 166 as shown in FIG. 12 are pinhole-like openings 170_{p,q} whose diameter is, for example, about 15 μm.

Referring back to FIG. 11, openings 172₁, 172₂ are made in the center of the band areas in the ends in the Y-direction of the lens-holding member 162 respectively. A reference pattern 174₁ is formed opposite the opening 172₁ on the bottom surface (pattern surface) of the glass substrate 160 as shown in FIG. 13. Although not shown, a reference pattern 174₂ identical to the reference pattern 174₁ is formed opposite the other opening 172₂ on the bottom surface (pattern surface) of the glass substrate 160.

Moreover, as shown in FIG. 11, a pair of reticle alignment marks RM1, RM2 is formed symmetrically with respect to the reticle's center, on the center line parallel to the X-direction of the glass substrate 160 and outside the lens-holding member 162.

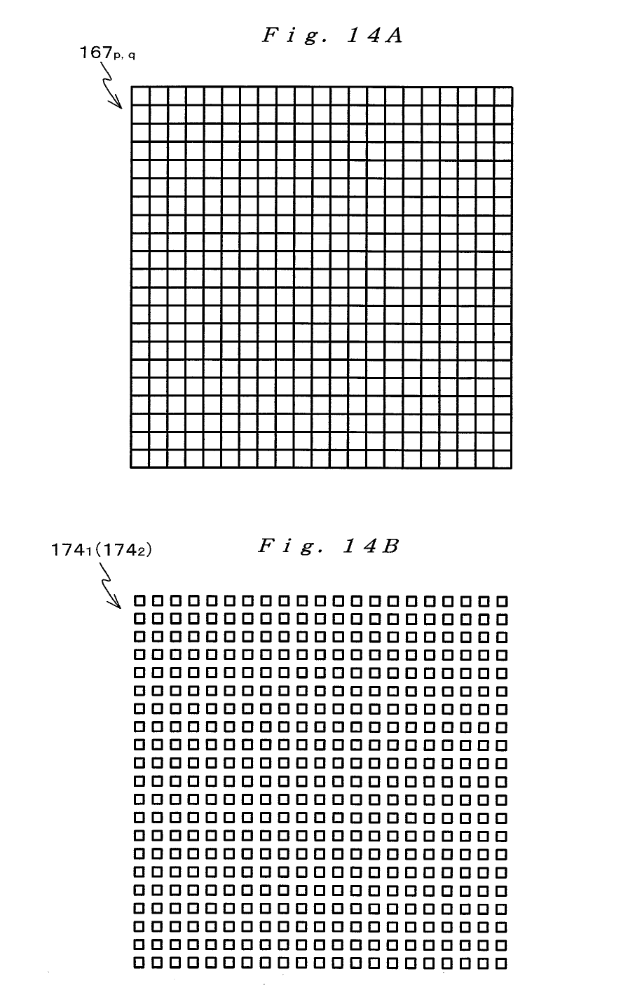

Here, in this embodiment, the measurement patterns 167_{p,q} are a mesh (street-lines-like) pattern as shown in FIG. 14A. Corresponding to these, the reference patterns 174₁, 174₂ are a two-dimensional pattern with square features arranged at the same pitch as the measurement pattern 167_{p,q} as shown in FIG. 14B. It is remarked that the reference pattern 174₁, 174₂ may be the pattern of FIG. 14A while the measurement pattern is the pattern of FIG. 14B. Furthermore, the measurement pattern 167_{p,q} may be a pattern having a different shape, in which case the corresponding reference pattern needs to be a pattern having a predetermined positional relation with the measurement pattern. That is, the reference pattern only has to be a pattern providing the reference for position deviation of the measurement pattern, and it does not matter what the shape of the reference pattern is.

Next, the measurement of the wave-front aberration due to the projection optical system PL of the exposure apparatus 60 using the reticle RT′ will be described.

First the wave-front aberration is measured for a plurality of measurement points (herein, R points) within the field of the projection optical system PL using the measurement reticle RT′ in the following manner.

The measurement reticle RT′ is loaded onto the reticle stage RST via a reticle loader (not shown), and the main control system 20 moves the wafer stage WST via the wafer-stage driving portion 24 with monitoring the output of the wafer interferometer 18 such that a pair of reticle alignment reference marks on the reference mark plate (not shown) is positioned at a predetermined reference position, specifically for example, such that the center of the pair of reference marks coincides with the origin of the stage coordinate system defined by the wafer interferometer 18.

Next, while simultaneously observing a pair of reticle alignment marks RM1, RM2 on the measurement reticle RT′ and the reticle alignment reference marks corresponding thereto using the reticle alignment microscopes, the main control system 20 finely drives the reticle stage RST along the X-Y two-dimensional plane via a driving system (not shown) such that position deviations of projected images on the reference plate of the reticle alignment marks RM1, RM2 from the reference marks becomes minimal. By this, reticle alignment is completed, and the center of the reticle almost coincides with the optical axis of the projection optical system PL.

Next, a wafer W whose surface is coated with a resist (photosensitive material) is loaded onto the wafer holder 25 via a wafer loader (not shown).

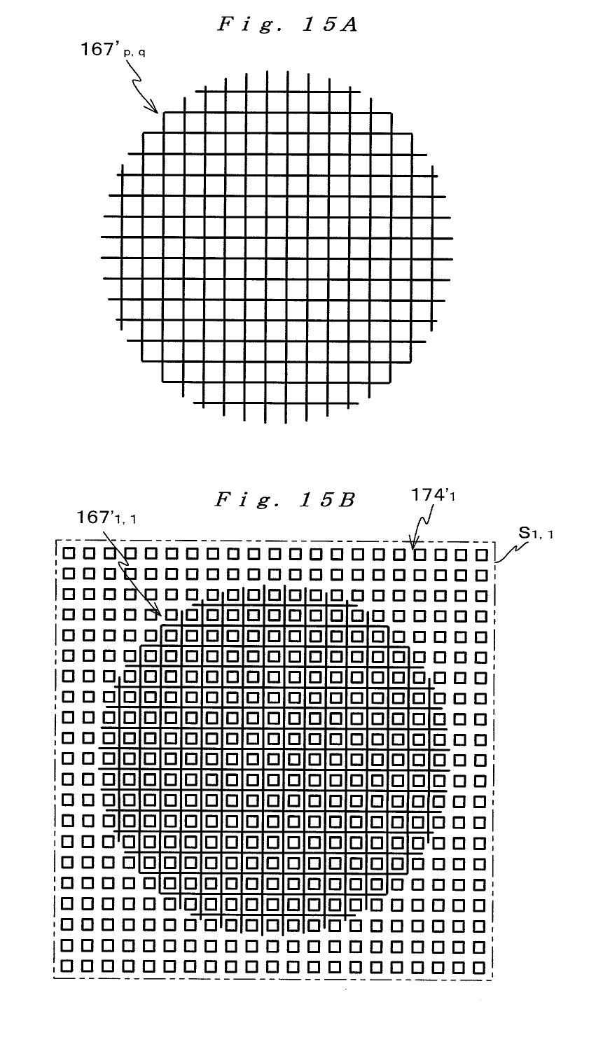

Then the main control system 20 illuminates the reticle RT′ with the illumination light IL for exposure. By this, as shown in FIG. 12, the measurement patterns 167_{p,q} are simultaneously transferred through the pinhole-like openings 170_{p,q} and the projection optical system PL. As a result, the reduced images 167′_{p,q} (latent images) of the measurement patterns 167_{p,q,} as shown in FIG. 15A, are formed spaced a predetermined distance apart from each other two-dimensionally on the resist layer on the wafer W.

Next, the main control system 20 moves the reticle stage RST in the Y-direction by a predetermined distance via a reticle-stage driving portion (not shown) based on a measurement value of a reticle interferometer 16 and positional relation planned in design between the reticle's center and the reference pattern 174₁ such that the center of the reference pattern 174₁ is placed on the optical axis AX. Next, the main control system 20 sets the reticle blind such that the illumination light IL only illuminates a rectangular area on the lens-holding member 162 having a predetermined size and including the opening 172₁ (but not any condenser lens).

Then the main control system 20 moves the wafer stage WST with monitoring measurement values of the wafer interferometer 18 such that the center of the latent image 167′_{1,1} on the wafer W of the first measurement pattern 167_{1,1} is placed almost on the optical axis AX.

Then the main control system 20 illuminates the reticle RT′ with the illumination light IL for exposure. By this, the reference pattern 174₁ is transferred and overlaid onto the area where the latent image of the measurement pattern 167_{1,1} is already formed on the resist layer on the wafer W, the area being called an area S_{1,1}. As a result, the latent images 167′_{1,1} and 174′₁ of the first measurement pattern 167_{1,1} and the reference pattern 174₁ are formed on the area S_{1,1} in a positional relation as shown in FIG. 15B.

Next, the main control system 20 calculates the arrangement pitch of the measurement patterns 167_{p,q} on the wafer W, which pitch is planned in design, based on the arrangement pitch of the measurement patterns 167_{p,q} on the reticle RT′ and the projection magnification of the projection optical system PL and moves the wafer stage WST in the X-direction by the pitch such that the center of an area S_{1,2} where the latent image of the second measurement pattern 167_{1,2} is formed is placed almost on the optical axis of the projection optical system PL.

Then the main control system 20 controls the illumination system 10 to illuminate the reticle RT′ with the illumination light IL for exposure. By this, the reference pattern 174₁ is transferred and overlaid onto the area S_{1,2} on the wafer W.

After that, stepping likewise between the areas and exposure are repeated, so that latent images, as shown in FIG. 15B, of the measurement pattern and the reference pattern are formed in each of the areas S_{p,q} on the wafer W.

After the completion of exposure, the wafer W is unloaded from the wafer holder 25 via the wafer loader (not shown) and is transferred to a coater-developer (not shown; hereinafter, “C/D” for short) which develops the wafer W, so that resist images, in the same arrangement as shown in FIG. 15B, of the measurement pattern and the reference pattern are formed in each of the areas S_{p,q} arranged in a matrix on the wafer W.

After that, the wafer W already developed is removed from the C/D and an external overlay measuring unit (registration measuring unit) measures overlay errors in the areas S_{p,q}. Because it is a known one, the description of the overlay measuring unit is omitted.

Based on the measuring result, position errors (position deviations) of the resist images of the measurement patterns 167_{p,q} from the corresponding reference pattern 174₁ are calculated. It is remarked that while there are various methods of calculating the position deviations, statistical computation is preferably employed based on measured raw data in terms of improving accuracy.

In this manner, for the areas S_{p,q}, X-Y-two-dimensional position deviations of the measurement patterns each from the corresponding reference pattern are obtained, which data is supplied to the main control system 20.

Based on the position deviation data obtained from the R measurement points (corresponding to the areas S_{p,q}) within the field of the projection optical system PL, the main control system 20 calculates the aberration components of the first through M'th order terms of the series in which the wave-front (wave-front aberration) is expanded, and corrects the calculating result in the same way as in the above embodiment.

Next, the physical relation between the position deviations and the wave-front will be briefly described with reference to FIGS. 12 and 13.

As represented by a measurement pattern 167_{k,l} in FIG. 12, one of sub-beams diffracted by a measurement pattern 167_{p,q} passes through a respective pinhole-like opening 170_{p,q} and then the pupil plane of the projection optical system PL in a different position depending on the position of the measurement pattern 167_{p,q}. That is, wave-front's part in each position on the pupil plane mainly reflects the wave-front of the sub-beam from the corresponding measurement pattern 167_{p,q} If the projection optical system PL caused no aberration, the wave-front on the pupil plane of the projection optical system PL would become an ideal one (herein, a flat plane) indicated by a numerical reference F₁. However, because projection optical systems that cause no aberration do not exist, the wave-front on the pupil plane becomes a curved surface F₂ represented by a dotted curve for example. Therefore, the measurement pattern 167_{p,q} is imaged in a position on the wafer W that deviates according to the angle that the curved surface F₂ makes with the ideal wave-front.

Meanwhile, light diffracted by the reference pattern 174₁ (or 174₂ ), as shown in FIG. 13, is not restricted by a pinhole-like aperture, is made incident directly on the projection optical system PL and is imaged on the wafer W through the projection optical system PL. Moreover, because exposure of the reference pattern 174₁ is performed in a state where the center of the reference pattern 174₁ is positioned on the optical axis of the projection optical system PL, almost no aberration of the imaging beam from the reference pattern 174₁ is caused by the projection optical system PL, so that the image is formed with no position deviation on a small area that the optical axis passes through.

Therefore, the position deviations directly reflect the tilts of the wave-front to an ideal wave-front, and based on the position deviations the wave-front can be drawn. It is noted that as the physical relation between the position deviations and the wave-front indicates, the principle of this modified example for calculating the wave-front is equivalent to that of the above embodiment.

Disclosed in U.S. Pat. No. 5,978,085 is a technology where measurement patterns and a reference pattern on a mask having the same structure as the measurement reticle RT′ are imaged on a substrate through a projection optical system, and where position deviations of the resist images of the measurement patterns from the respective resist images of the reference pattern are measured to calculate the wave-front aberration based on the measuring result.

It is remarked that although in the above embodiment cross talk between order terms is corrected for in which higher-order aberration components blend into lower-order aberration components, cross talk between lower-order terms can also be corrected for, in which case, when calculating the correction information before, the amounts of cross talk between lower-order terms are also calculated based on a mathematical model for the wave-front-aberration measuring unit 70 in order to obtain the correction information.

In addition, although in the above embodiment the wave-front aberration is expanded in a set of fringe Zernike polynomials as a basis (or series), another basis can be used to expand the wave-front aberration in to obtain aberration components of desired order terms.

Moreover, although in the above embodiment measuring the wave-front aberration according to the prior art Shack-Hartmann technique is performed, observing interference fringes by using a shearing interferometer to measure the wave-front may be performed instead. Also in this case the wave-front aberration can be accurately obtained by doing the same correction as in the above embodiment.

Furthermore, although in the above embodiment the wave-front-aberration measuring unit 70 is removed from the exposure-apparatus main body 60 before exposure, needless to say, exposure may be performed without removing the wave-front-aberration measuring unit 70.

In addition, in the above embodiment a second CCD for measuring the shape of the pupil of an optical system to be examined may be provided. For example, in FIG. 2 the second CCD may be arranged behind a half mirror in place of the reflection mirror 96b and at a position optically conjugate to the pupil of the optical system to be examined. The center of the CCD 95 can be made to coincide with the center of the projection optical system's pupil by using the second CCD, so that the position deviations of spot images from the center of the pupil can be measured.

In addition, while the above embodiment describes the case where the scan-type exposure apparatus is employed, this invention can be applied to any exposure apparatus having a projection optical system regardless of whether it is of a step-and-repeat type, a step-and-scan type, or a step-and-stitching type.

Yet further, while in the above embodiment this invention is applied to aberration measurement of the projection optical system of an exposure apparatus, not being limited to an exposure apparatus, this invention can be applied to aberration measurement of imaging optical systems of other kinds of apparatuses.

Yet further, this invention can also be applied to, for example, measurement of an optical characteristic of a reflection mirror and the like.

<<Manufacture of Devices>>

Next, the manufacture of devices by using the above exposure apparatus and method will be described.

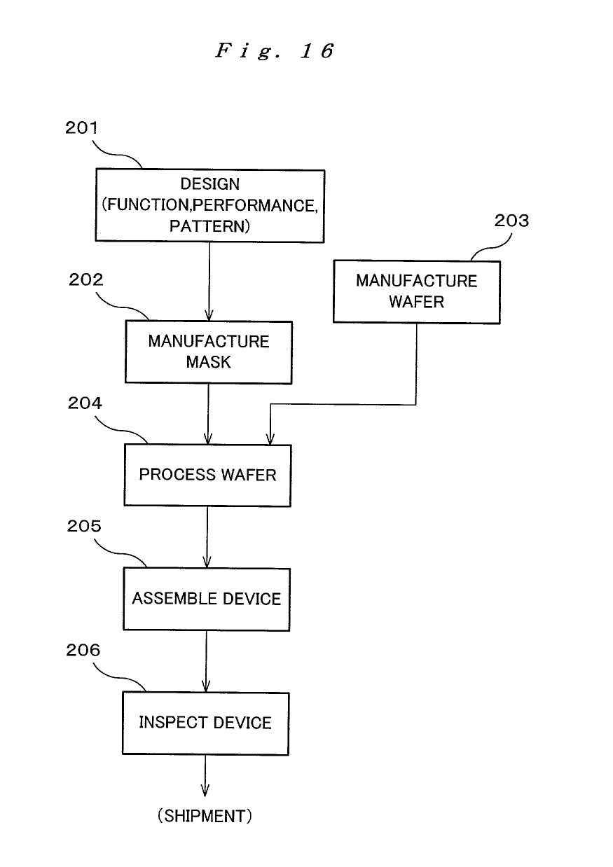

FIG. 16 is a flow chart for the manufacture of devices (semiconductor chips such as IC or LSI, liquid crystal panels, CCD's, thin magnetic heads, micro machines, or the like) in this embodiment. As shown in FIG. 16, in step 201 (design step), function/performance design for the devices (e.g., circuit design for semiconductor devices) is performed and pattern design is performed to implement the function. In step 202 (mask manufacturing step), masks on which a different sub-pattern of the designed circuit is formed are produced. In step 203 (wafer manufacturing step), wafers are manufactured by using silicon material or the like.

In step 204 (wafer processing step), actual circuits and the like are formed on the wafers by lithography or the like using the masks and the wafers prepared in steps 201 through 203, as will be described later. In step 205 (device assembly step), the devices are assembled from the wafers processed in step 204. Step 205 includes processes such as dicing, bonding, and packaging (chip encapsulation).

Finally, in step 206 (inspection step), a test on the operation of each of the devices, durability test, and the like are performed. After these steps, the process ends and the devices are shipped out.

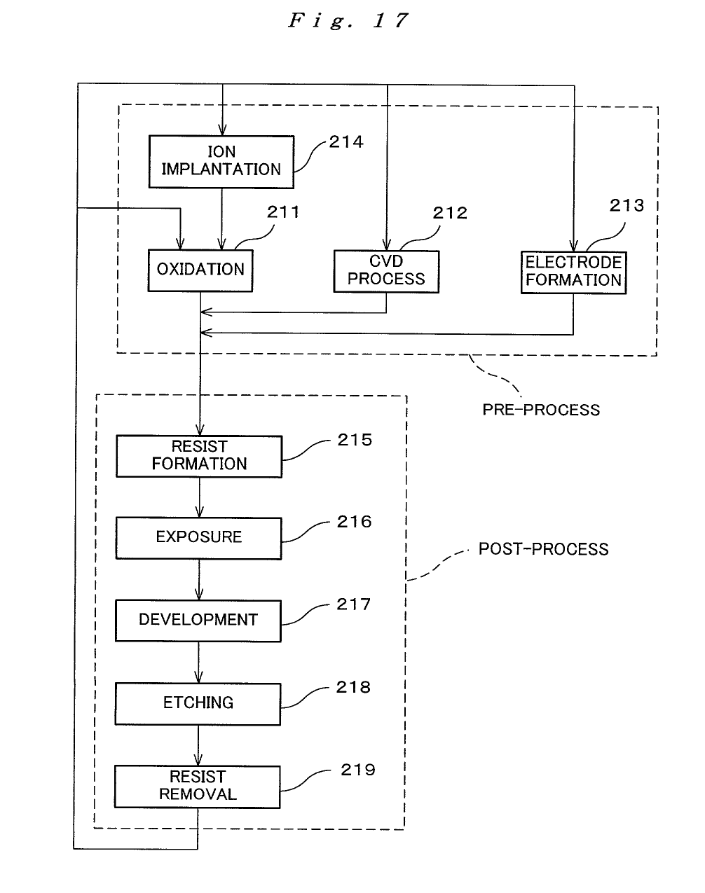

FIG. 17 is a flow chart showing a detailed example of step 204 described above in manufacturing semiconductor devices. Referring to FIG. 17, in step 211 (oxidation step), the surface of a wafer is oxidized. In step 212 (CVD step), an insulating film is formed on the wafer surface. In step 213 (electrode formation step), electrodes are formed on the wafer by vapor deposition. In step 214 (ion implantation step), ions are implanted into the wafer. Steps 211 through 214 described above constitute a pre-process for each step in the wafer process and are selectively executed in accordance with the processing required in each step.

When the above pre-process is completed in each step in the wafer process, a post-process is executed as follows. In this post-process, first of all, in step 215 (resist formation step), the wafer is coated with a photosensitive material (resist). In step 216, the above exposure apparatus transfers a sub-pattern of the circuit on a mask onto the wafer according to the above method. In step 217 (development step), the exposed wafer is developed. In step 218 (etching step), an exposing member on portions other than portions on which the resist is left is removed by etching. In step 219 (resist removing step), the unnecessary resist after the etching is removed.

By repeatedly performing these pre-process and post-process, a multiple-layer circuit pattern is formed on each shot-area of the wafer.

In the above manner, the devices on which a fine pattern is accurately formed are manufactured.

Although the embodiments according to the present invention are preferred embodiments, those skilled in the art of lithography systems can readily think of numerous additions, modifications and substitutions to the above embodiments, without departing from the scope and spirit of this invention. It is contemplated that any such additions, modifications and substitutions will fall within the scope of the present invention, which is defined by the claims appended hereto.

What is claimed is:

1. A wave-front aberration measuring method with which to measure a wave-front aberration in an optical system subject to measurement, said measuring method comprising:
measuring, first, aberration components of a first set of order terms out of aberration components of order terms of a predetermined basis in which the wave-front aberration in said optical system is expanded;
calculating correction information for aberration components of a second set of order terms based on a predetermined order term's aberration component out of the aberration components of said first set of order terms;
measuring aberration components of said second set of order terms in said optical system; and
correcting the result of said measuring of aberration components of said second set of order terms based on said correction information.

2. A wave-front aberration measuring method according to claim 1, wherein the expansion in said predetermined basis is an expansion in a set of fringe Zernike polynomials.

3. A wave-front aberration measuring method according to claim 1, wherein said first set of order terms include all of a lowest order term through a first ordinal order term in said expansion, and wherein said second set of order terms include all of said lowest order term through a second ordinal order term in said expansion, said second ordinal being lower than said first ordinal.

4. A wave-front aberration measuring method according to claim 3, wherein said predetermined order term is included in said first set of order terms and not in said second set of order terms, wherein calculating said correction information comprises:
calculating a first wave-front with letting aberration components of other order terms of said first set of order terms measured than said predetermined order term be zero; and
calculating as said correction information respective correction amounts for aberration components of said second set of order terms based on a model for a measuring system that measures aberration components of said second set of order terms and said first wave-front, and
wherein the aberration components of said second set of order terms measured are individually corrected based on said correction information.

5. A wave-front aberration measuring method according to claim 3, wherein said predetermined order term is included in said first set of order terms and not in said second set of order terms, wherein calculating said correction information comprises calculating as said correction information a first wave-front with letting aberration components of other order terms of said first set of order terms measured than said predetermined order term be zero, and
wherein correcting based on said correction information comprises:
calculating a second wave-front that has aberration components of said second set of order terms measured by a measuring system that measures aberration components of said second set of order terms;
calculating a third wave-front by correcting said second wave-front based on said first wave-front; and
calculating corrected aberration components of said second set of order terms, based on said third wave-front and a model for said measuring system.

6. A wave-front aberration measuring method according to claim 1, wherein measuring aberration components of said second set of order terms comprises:
forming a plurality of pattern images by dividing by use of a predetermined optical system a wave-front of light having passed through said optical system; and
calculating aberration components of said second set of order terms, based on positions of said plurality of pattern images formed.

7. A wave-front aberration measuring method according to claim 1, wherein measuring aberration components of said second set of order terms comprises:
imaging, after placing at the object plane of said optical system a plurality of divided pattern areas on each of which a pattern that produces light passing through a respective area of a plurality of areas on the pupil plane of said optical system is formed, said patterns formed on said plurality of divided pattern areas through said optical system; and
calculating aberration components of said second set of order terms, based on positions of images of said pattern, formed by said optical system.

8. A wave-front aberration measuring unit which measures a wave-front aberration in an optical system subject to measurement, said measuring unit comprising:
a storage unit that stores calculated correction information for aberration components of a second set of order terms based on a predetermined order term's aberration component out of aberration components of a first set of order terms measured before out of aberration components of order terms of a predetermined basis in which the wave-front aberration in said optical system is expanded;
a measuring system that measures aberration components of said second set of order terms of the wave-front aberration in said optical system; and
a correcting unit that corrects the measuring result of said measuring system with said correction information.

9. A wave-front aberration measuring unit according to claim 8, wherein the expansion in said predetermined basis is an expansion in a set of fringe Zernike polynomials.

10. A wave-front aberration measuring unit according to claim 8, wherein said measuring system comprises:
a wave-front dividing device that divides a wave-front of light having passed through said optical system to form a plurality of pattern images; and
an aberration-component calculating unit that calculates aberration components of said second set of order terms, based on positions of said plurality of pattern images formed.

11. A wave-front aberration measuring unit according to claim 10, wherein said wave-front dividing device is a micro-lens array where lens elements are arranged in a matrix.

12. A wave-front aberration measuring unit according to claim 8, wherein said measuring system comprises:
a pattern-formed member that is placed on the object plane's side of said optical system and has a plurality of divided pattern areas on each of which a pattern that produces light passing through a respective area of a plurality of areas on the pupil plane of said optical system is formed; and
an aberration-component calculating unit that calculates aberration components of said second set of order terms, based on positions of images of said pattern, formed by said optical system.

13. An exposure apparatus which transfers a given pattern onto a substrate by illuminating said substrate with exposure light, said apparatus comprising:
an exposure apparatus main body that comprises a projection optical system arranged on the optical path of said exposure light; and
a wave-front aberration measuring unit according to claim 8 with said projection optical system as an optical system subject to measurement.

14. A device manufacturing method including a lithography process, wherein in the lithography process, an exposure apparatus according to claim 13 performs exposure.

15. A device manufactured according to the device manufacturing method of claim 14.
